(19) United States
(12) Patent Application Publication
(10) Pub. No.: US 2022/0165172 A1
(43) Pub. Date: May 26, 2022

(54) METHOD AND SYSTEM FOR INTERACTIVE LEARNING

(71) Applicant: Meego Technology Limited, Sheung Wan (HK)

(72) Inventor: Kathleen TING, Sheung Wan (HK)

(73) Assignee: Meego Technology Limited, Sheung Wan (HK)

(21) Appl. No.: 17/594,077

(22) PCT Filed: Apr. 2, 2020
(86) PCT No.: PCT/IB2020/053135

§ 371 Date: Oct. 1, 2021

(30) Foreign Application Priority Data
Apr. 3, 2019 (HK) 19121874.2
Nov. 26, 2019 (HK) 19132759.2

(51) Int. Cl. G09B 7/08; G09B 7/07; G09B 5/06; G09B 19/06

(52) U.S. Cl. CPC G09B 7/08; G09B 19/06; G09B 5/065; G09B 7/07

(57) ABSTRACT

A method, system and computer readable medium for interactive learning between computing devices interconnected across a network with a server includes at least one guide operable computing device that communicates with student operable computing devices. During a learning session, the processor of the student operable computing device generates a student interface displaying a question from a library and captures an answer input thereto during a learning session. The processor of the guide operable computing device generates an interface displaying one or more questions; any associated possible answers and notes thereon and for displaying the answer input from the student operable computing device. The processor of the at least one guide operable computing device captures input on said student answer input via the interface for transmission across the network to the student operable computing device for display during the session.

### FIELD

The present invention relates to a method and system for facilitating interactive learning over a computer network.

### BACKGROUND

With the rapid development of personal computing devices such as tablets, smart phones and portable computers with capacity to interconnect with each other and with computing networks such as the internet, today's students can rapidly search for and access knowledge from a wide variety of sources.

However, where such resources are provided to a group of students over a network, there is limited if any transparency in the feedback on individual students performance—with such feedback typically only provided by scores at the end of the unit, term or semester through traditional examinations or assignments. Alternatively, where students provide answers to automatically generated questions in a module, separation of the evaluation of the answer and subsequent review by the teacher of the performance metric mean that understanding of the students progression is lost.

It is therefore very difficult for an instructor assigning such resources to individual students to monitor individual student's progression through the learning resources; which compromises the learning outcome achieved by the students. Additionally, each student may engage and assimilate the material provided at different rates, with consequential errors or learning blocks impeding progression.

Accordingly, the use of network accessible learning resources falls short of providing an immersive and rounded learning experience for students, especially student's undertaking online language learning.

Accordingly, it is an objective of the present disclosure to provide a method and system which at least partially ameliorates or at least addresses some of the above identified disadvantages.

### SUMMARY

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In an aspect of the present disclosure, there is provided an interactive learning system comprising: at least one server communicatively coupled to a database having a plurality of student profiles and a plurality of computing devices interconnected across a network, said plurality of computing devices comprising at least one guide operable computing device in communication with a plurality of student operable computing devices; and said at least one server being coupled to a database of learning resources including a library of questions at least some of said questions being associated with possible answers and notes; wherein during a learning session between at least one guide operable computing device and at least one student operable computing device accessed by a student with a profile on said at least one server via the network, the processor of the at least one student operable computing device configured for generating a student interface displaying a question from the library and capturing an answer input thereto during a learning session; and the processor of said guide operable computing device configured for generating a guide interface displaying one or more questions; any associated possible answers and notes thereon and for displaying the answer input from the student operable computing device, wherein said processor of the at least one guide operable computing device is further configured to capture input on said student answer input via the guide interface for transmission across the network to the at least one student operable computing device for display on the student interface during the session.

The next question may be automatically selected from the library according to a student's performance data comprising one or more of the following correctness of the student's answer to one or more preceding questions, the student's average response time in answering one or more preceding questions, and a count of the instances of switching between answer options in the one or more preceding questions.

The next question may be automatically selected from a stored library of questions according to attributes of the question including a difficulty level, topic, type, length, grading criteria, and relationships with other questions.

Alternatively, the next question may be automatically selected from the library according to a combination of the student's performance data comprising one or more of the following correctness of the student's answer to one or more preceding questions, the student's average response time in answering one or more preceding questions, and a count of the instances of switching between answer options in the one or more preceding questions; and the attributes of the question including a difficulty level, topic, type, length, grading criteria, and relationships with other questions.

Optionally, the next question may be manually selected by a guide from the plurality of questions in the library of questions.

The questions may be in a format selected from the group of formats comprising multiple choice questions having one correct answer selectable from a plurality of options, multiple choice questions having at least two or more correct answers selectable from a plurality of options and a short answer question.

The question may be in a short answer question format, the processor of the student operable computing device may be configured for generating an interface having a region for capturing answer input from the student and a region proximal thereto for displaying during the session input received from the guide on said student answer input.

Alternatively, the question may be in a short answer question format, the processor of the guide operable computing device may be configured for generating an interface for displaying during the answer input from the student and for capturing input on the student's answer input during the learning session.

The input may be a performance score.

Optionally, the answers provided from a student operable computing device to the plurality of questions in a session together with any input received from the guide is stored against the corresponding student profile.

The system may be configured for providing automatically generated evaluation of a student answer input during a session for at least one or more questions for display on the interface of the student operable device, wherein the evaluation is made by comparison of the answer input to at least one or more questions and the associated answer for the at least one or more questions stored in the library of questions.

The student answer input may be multiple choice answer input and the correctness thereof may be automatically detected and displayed on the interface generated by the guide operable computing device during the learning session by comparing the answer input against the correct answer stored for that questions in the library of questions.

Optionally, attributes of at least one question in the plurality of questions in the library of questions including a difficulty level, topic, type, length, grading criteria, and relationships with other questions are specified prior to or during a session.

Advantageously, the interactive learning system may further include an interface configured to receive from one or more authorised users additional questions for inclusion in a stored library of questions wherein at least one or more attributes of the question including difficulty level, topic, type, length, grading criteria, and relationships with other questions are also captured.

The or each of the guide or student operable devices may be configured to generate an interface displaying at the conclusion of the session the questions issued during the session, the answers input in response, correct answers and any comments provided thereto.

Optionally, a region of the interface generated on the guide operable computing device may be configured for displaying a first image stream captured by an image acquisition means of the student operable computing device proximal to a second image stream captured by the guide operable computing device during the learning session; and wherein a region of the interface generated on the student operable computing device may be configured for displaying the second image stream captured by an image acquisition means of the guide operable computing device during the learning session proximal to the first image stream captured by the student operable computing device during the learning session.

The questions may be in a first language and the answers may be in a language different from the first language.

Optionally, the processor of the guide operable computing device may be configured for generating an interface during a learning session including a lexicon region having at least one or more editable elements, each element associating input of a morpheme in a first language or a corresponding phonetic representation thereof with a definition in a second language; wherein said lexicon and any modifications thereof may be transmitted via the server to the or each student operable computing device during a learning session.

An element may be included in the lexicon region by receiving input comprising a morpheme or phonetic representation and displaying the corresponding morpheme or phonetic representation retrieved from a plurality of stored associations between morphemes and phonetic representations; and for receiving a specified definition thereof for transmission of that element and any modifications thereto via the server to the or each student operable computing device in the learning session.

Optionally, the morpheme may comprise at least one or more logograms.

The at least one or more logograms may be a Chinese hanzi, Korean hanya or Japanese kanji Character and the corresponding phonetic representation is an English language Romanisation thereof.

Advantageously, the lexicon region of the interface may be dynamically updated by the guide during the learning session to display elements thereof on the interface generated by the student operable computing devices.

The lexicon region of the interface may include a plurality of elements specified by an instructor prior to commencement of the learning session; said elements being able to be added to, deleted or modified by the guide during the learning session.

Optionally, the elements in the lexicon region of each learning session for each student may be stored on the server.

In another aspect of the present disclosure, there is provided an interactive learning system comprising: at least one server communicatively coupled to a database having a plurality of student profiles and a plurality of computing devices interconnected across a network, said plurality of computing devices comprising at least one instructor operable computing device having a processor configured for communication with a plurality of student operable computing devices; and said server being coupled to a database of learning resources including a library of questions and associated correct answers; wherein the processor of said instructor operable computing device is also configured for generating an interface for specifying one or more questions to be assigned to a learning session for answering by at least one or more students; and wherein during a learning session established between the server and at least one student operable computing device accessed by a student with a profile on said server via the network, the processor of the at least one student operable computing device is configured for generating a student interface displaying an assigned question from the library; capturing an answer input thereto during a learning session; and displaying a determination of the correctness thereof based upon a comparison with the associated correct answer on the server for the assigned question.

In a further aspect of the present disclosure, there is provided a non-transitory computer readable storage medium storing one or more programs, the one or more programs comprising instructions, which when executed by an electronic device with a display, cause the device to perform operations including: establishing a learning session with at least one student operable computing device across a network via at least one server; said at least one student operable computing device being authenticated by locating a corresponding student profile in a database coupled to the at least one server; generating a guide interface displaying one or more questions; any associated possible answers and notes thereon in a database of learning resources including a library of questions at least some of said questions being associated with possible answers and notes; displaying the answer input from the student operable computing device on said guide interface; capturing input on said student answer input via the guide interface for transmission across the network to the at least one student operable computing device for display on the student interface during the session.

In a still another aspect of the present disclosure, there is provided the non-transitory computer readable storage medium storing or more programs, the one or more programs comprising instructions, which when executed by an electronic device with a display, cause the device to perform operations including: generating an interface during a learning session including a lexicon region having at least one or more editable elements, each element associating input of a morpheme in a first language or a corresponding phonetic representation thereof with a definition in a second language; wherein said lexicon and any modifications thereof are transmitted via the server to the or each student operable computing device during a learning session.

In a still further aspect of the present disclosure, there is provided a method of providing an interactive learning session between at least one student operable computing device and at least one guide operable computing device across a network via at least one server; the method comprising: establishing a learning session between a guide operable computing device and at least one student operable computing device; said at least one student operable computing device being authenticated by locating a corresponding student profile in a database coupled to the at least one server; generating a guide interface on the guide operable computing device for displaying one or more questions; any associated possible answers and notes thereon from a database of learning resources including a library of questions at least some of said questions being associated with possible answers and notes; displaying the answer input from the student operable computing device on said guide interface; capturing input on said student answer input via the guide interface for transmission across the network to the at least one student operable computing device for display on the student interface during the session.

The method may further comprise: generating an interface during a learning session including a lexicon region having at least one or more editable elements, each element associating input of a morpheme in a first language or a corresponding phonetic representation thereof with a definition in a second language; wherein said lexicon and any modifications thereof are transmitted via the server to the or each student operable computing device during a learning session.

In a still further aspect of the present disclosure, there is provided a method of providing an interactive learning session between at least one student operable computing device across a network and at least one server, the method may comprise: capturing inclusion of at least one or more questions in a learning session via an interface generated by a processor of an instructor operable computing device, wherein said questions are from a database of learning resources comprising a library of questions and associated correct answer(s); wherein the instructor is authenticated by locating against a corresponding instructor profile in the database coupled to at least one server across a network; establishing a learning session for a student operable computing device authenticated by locating a corresponding student profile in the database coupled to at least one server across a network; and generating a student interface on the student operable computing device for displaying questions included via the interface of the instructor operable computing device; capturing an answer input thereto during a learning session and displaying a determination of the correctness thereof based upon a comparison with the associated correct answer on the server for the included questions in that learning session.

### BRIEF DESCRIPTION OF THE FIGURES

In order to describe the manner in which the above-recited and other advantages and features of the disclosure can be obtained, a more particular description of the principles briefly described above will be rendered by reference to specific embodiments thereof which are illustrated in the appended figures. Understanding that these figures depict only exemplary embodiments of the disclosure and are not therefore to be considered to be limiting of its scope, the principles herein are described and explained with additional specificity and detail through the use of the accompanying figures.

Preferred embodiments of the present invention will be explained in further detail below by way of examples and with reference to the accompanying drawings, in which:

FIG. 1A depicts an exemplary system architecture for an interactive learning system according to an embodiment of the present disclosure.

FIG. 1B depicts an exemplary logical system architecture for the interactive learning system of FIG. 1A.

FIG. 2 depicts an exemplary interface including a number of elements for an interface for display on either a student or guide operable computing device during a learning session.

FIG. 3A depicts an exemplary single answer multiple choice question element for display on the exemplary interface of FIG. 2, where the interface is displayed on a student operable computing device.

FIG. 3B depicts an exemplary multiple answer multiple choice question element for display on the exemplary interface of FIG. 2, where the interface is displayed on a student operable computing device.

FIG. 3C depicts an exemplary short answer element for display on the exemplary interface of FIG. 2, where the interface is displayed on a student operable computing device.

FIG. 4A depicts the exemplary single answer multiple choice question element for display on the exemplary interface of FIG. 2, where the interface is displayed on a guide operable computing device.

FIG. 4B depicts an exemplary multiple answer multiple choice question element for display on the exemplary interface of FIG. 2, where the interface is displayed on a guide operable computing device.

FIG. 4C depicts an exemplary short answer element for display on the exemplary interface of FIG. 2 where the interface is displayed on a guide operable computing device.

FIG. 5 depicts an exemplary interface displayed on a guide operable computing device configured for addition of a question to the library of questions.

FIG. 6 depicts an exemplary portion of an interface depicting how individual and group student performance in a session may be represented to an authorised user.

FIG. 7A depicts an exemplary interface for capturing information on the learning session from a student operable computing device.

FIG. 7B depicts an exemplary interface for capturing information on the learning session provided by a guide of that session.

FIG. 7C depicts an exemplary interface for displaying previous sessions.

FIG. 7D depicts an exemplary interface for displaying specific questions answered by a student in a learning session, being generated from information stored for that session on a server after choosing to review the exemplary interface of FIG. 7C.

FIG. 8A depicts an exemplary portion of the language resource region of the interface of FIG. 2 generated by a guide operable computing device, in this case for a Chinese English language pairing.

FIG. 8B depicts a corresponding exemplary language resource region of FIG. 2 as generated by a student operable computing device during a session, in this case for a Chinese English language pairing.

FIG. 8C depicts an exemplary portion of the language resource region of the interface of FIG. 2 generated by a guide operable computing device during a session, in this case for a Korean English language pairing.

FIG. 8D depicts an exemplary portion of the language resource region of the interface of FIG. 2 generated by a guide operable computing device during a session, in this case for a Japanese English language pairing.

FIG. 9 is an exemplary flowchart depicting steps in the operation of the language resource region of FIG. 8A-8D.

FIG. 10A is an exemplary flowchart of a first representation of how the next question of the plurality of questions is selected.

FIG. 10B is a flowchart depicting more detailed representation of an alternative method for selection of the next question of the plurality of questions.

FIG. 11A is an exemplary interface depicting a further challenge embodiment from the perspective of a student.

FIG. 11B is an exemplary interface depicting the further challenge embodiment of FIG. 11A from the instructor perspective.

FIG. 11C is an exemplary interface showing the progression of students in an assigned challenge, viewable by an instructor.

### DETAILED DESCRIPTION OF THE PREFERRED EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for a system and method for facilitating learning across a network between students and a learning guide who are geographically remote from each other. Advantageously, the student and learning guide can be in a learning session which may involve a plurality of learning resources accessible across a network, with the learning resources including a library of questions which may be presented to the student to determine comprehension of topics to be covered in the learning session. The questions may be selected by the system or by the guide based on a number of attributes of the student(s) performance and the questions as is discussed in more detail below. In this way, the learning sessions provide interactive learning for the student, increasing understanding and progression through the material.

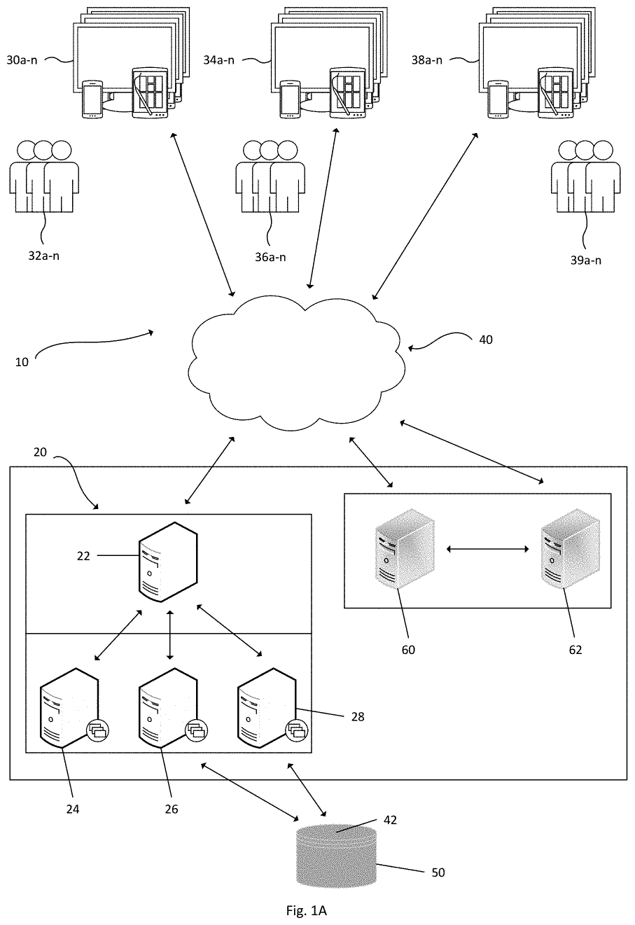

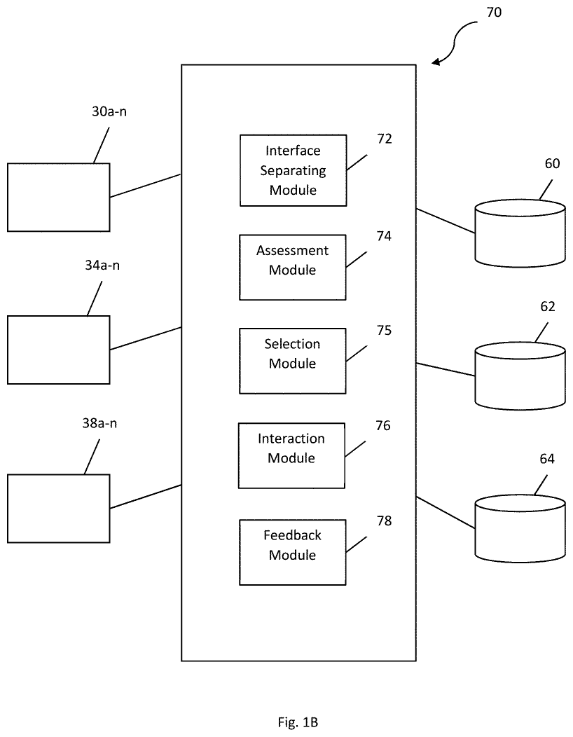

Referring to FIG. 1A there is depicted a schematic architectural diagram for an exemplary system 10 for implementing the present disclosure.

As depicted, the system 10 includes an API server 20 in communication across a network 40 with at least one or more instructor operable computing devices 30a-n, at least one or more student operable computing devices 34a-n and at least one or more guide operable computing devices 38a-n, hereinafter collectively referred to as user clients. As is known in the art, such computing devices may include personal electronic devices such as personal computers, laptops, tablets and “smartphones” without departing from the scope of the present disclosure.

Each of the instructors 32a-n, students 36a-n, and guides 39a-n access the API server 20 across a network 40; with access controlled via requisite specific and separate user profiles 42 stored on a database 50. Optionally the database 50 may also be configured to store user generated content, including learning session bookings made by instructors 32a-n operating instructor operable computing devices via an interface as described herein; curriculum resources combinations; user progression information and system configuration and audit logs.

It would be appreciated that the network 40 could comprise any form of wired or wireless data communications network such as a WAN, a LAN and the computers and networks forming the internet.

Access to the API Server is advantageously configured to be granted to authorised users via a load balancer 22, which distributes incoming connections according to server load and request type. The load balancer 22 communicates requests to other micro-services servers, including a real time services server 24, an API backend services server 26 and an email server(s) 28. The real time services server 24 is configured to provide real time sharing functionality for client interactions with various real time aspects of the system including text communication with and between clients, cursor and slide synchronisation etc. The API backend services server 26 may be configured to provide the user interface information for generation of the various interfaces of by the processor of the client computing devices as described herein; and to communicate with the database 50 across a wired or wireless network. The email services server 28 is similarly in communication with the database 50 to provide automated emails and notifications to the client devices as appropriate.

Advantageously, the user client computing devices are also in communication across the communications network with media server 60 through which live audio/video learning sessions offered by the system between student operable computing devices and guide operable computing devices may be provided. As discussed herein, such sessions may be monitored by an instructor operable computing device (assuming that instructor has an appropriate access profile) for quality assurance purposes by accessing data processed on media server 60. The media server 60 may also be communicatively coupled with and to asset server 62, on which video recordings of the sessions may be stored.

Further the client computing devices may also be in communication across the communications network 40 with asset server 62 on which data of learning sessions may be stored, as well as learning resources for such sessions including slides, images, audio and video clips.

It would be appreciated by a person skilled in the art that a variety of alternative configurations could also be provided analogous to the above schematic architecture. However, such configurations would also need to be capable of providing the necessary scalability offered by the system and method of the present disclosure, with the provided network infrastructure described maintaining the overall responsiveness and client experience within adequate performance metrics.

FIG. 1B depicts an exemplary logical system architecture for the interactive learning system of FIG. 1A.

The interactive learning apparatus 70 including processors and memory has a logical architecture as described herein. An interface generating module 72, an assessment module 74, a selection module 75, an interaction module 76 and a feedback module 78 are communicatively coupled together in the interactive learning apparatus. The interface generating module 72, assessment module 74, selection module 75, interaction module 76 and feedback module 78 may be stored in the memory for execution by one or more processors.

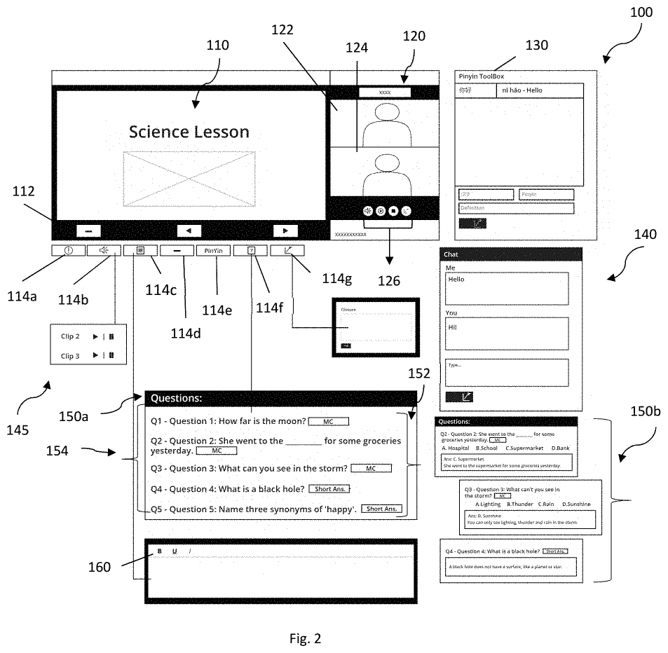

As discussed above, the interface generating module 72 generates appropriate interfaces for and upon receiving input from instructors, guides and/or students. It can be understood that the interface generating module 72 can generate a plurality of different interfaces depending on the input from a learner side (a student(s)) or a guide side (guide or instructors), including for example, the interfaces discussed above with references to FIGS. 2 to 10.

The assessment module 74 may be configured to assess the answers provided by the student(s) and provide automatically/manually generated evaluation of a student answer input during a session for at least one or more questions; with this input and the question being displayed on an appropriate interface. The evaluation may be made by comparison of the answer input to at least one or more questions and the associated answer for the at least one or more questions stored in the library of questions or by receiving manual input from the guide or instructor.

The selection module 75 may be configured to select next question(s) from the library according to a student's performance data comprising one or more of the following correctness of the student's answer to one or more preceding questions, the student's average response time in answering one or more preceding questions, and a count of the instances of switching between answer options in the one or more preceding questions. The next question(s) may also be selected from a stored library of questions according to attributes of the question including a difficulty level, topic, type, length, grading criteria, and relationships with other questions. In one embodiment the next question(s) may be selected from the library according to a combination of the student's performance data comprising one or more of the following correctness of the student's answer to one or more preceding questions, the student's average response time in answering one or more preceding questions, and a count of the instances of switching between answer options in the one or more preceding questions; and the attributes of the question including a difficulty level, topic, type, length, grading criteria, and relationships with other questions. It would be appreciated that the next question(s) may be also manually selected by a guide from the plurality of questions in the library of questions.

The interaction module 76 may be configured to provide interactive communication between student(s) and guide(s), for example, enabling the updating the language resource region 130 during the learning session, a chat 140, text entry box 160 and/or online video 120 and the like. Detail of the language resource region 130 during the learning session, a chat 140, text entry box 160 and/or online video 120 are further discussed below.

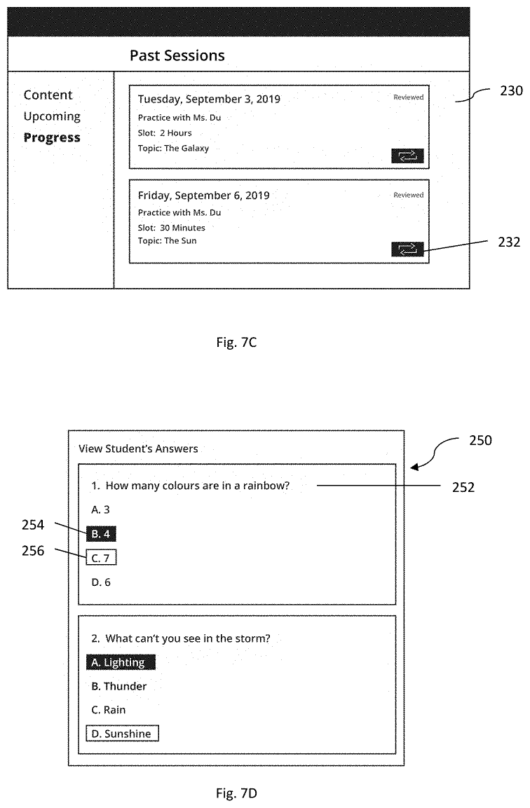

The apparatus may further include the feedback module 78 to collect feedback from students about their session and/or collect feedback from guides on a particular session with a particular student, as discussed above with references to FIGS. 7A and 7B.

It would be appreciated that the interface generating module 72, the assessing module 74, the selecting module 75, the interacting module 76 and the feedback module 78 can communicate with the media server 60, the asset server 62 and the database 50 for calling learning resources, student profiles and storing information generated during the learning session.

Referring now to FIG. 2, there is depicted an exemplary interface 100. It would be appreciated that this interface could be either a student operable interface, or alternatively a guide operable interface, depending on the information provided in the respective regions as is discussed in further detail below.

As depicted, there is a learning resources region 110, in which a plurality of learning material, for example slides, or other information may be displayed. Actuation of various learning resources control buttons 112 enables the student and/or guide to progress through the various learning resources which are displayed in the learning resources region 110.

Session control buttons 114a-114g enables a guide and/or student to control the progression of the session. As depicted, the session control buttons include a number of different options as are discussed in further detail below.

User actuable button 114a is a notification button for receiving user input of session readiness and transmitting it to the central server for provision to the other participant(s) in the session; whereby the same or other fields may be updated to indicate the readiness of the first user to commence a session.

Session control button 114b is a user actuable button which may be used to access learning clips which are supportive of the learning material displayed in learning region 110. It would be appreciated that such clips could be displayed in related windows or regions, as depicted in the Figure at item 145.

Referring to learning session control button 114c, there is depicted a writing pad region for receiving, displaying and transmitting input from a student and their assigned learning guide during a learning session—during “real time”.

As depicted, it would be appreciated that this actuation of the learning control button 114c is configured to trigger the expansion of the writing region 160, which could normally be minimized during a session depending on the configuration.

Learning control button 114d is actuable by a user to trigger a file chooser or other interface to select from appropriate learning resources in a library of learning resources for display on the learning resources region 110.

Session control button 114e is actuable by a user to trigger a language resource region (in this case Pinyin, an English form of representation of the Chinese language), which is described in further detail in due course, with an exemplary depiction shown at region 130. Such a language resource region would also be appropriate for sessions whereby the system and method are used for teaching online learning of one or more languages, although not restricted to Chinese.

Session control button 114f, is a question button, which when actuated is used to generate a question interface as depicted in region 150. As depicted, the question region 150a may include a plurality of questions 154 corresponding actuable answers button 152 for generating individual questions region 150b as discussed in further detail below.

Optionally, where the questions are short answer, actuation of such a button may trigger a text input region for capturing input or providing input on a short answer question for the students or guide operable computing device respectively.

Advantageously, the interface 100 may include a chat region 140 through which chat information between the learning guide and student may be inputted by either side on their respective computing devices, for example for clarification of specific aspects of the question or overall learning session.

Further depicted is a video feed region 120, which may include an upper image stream region 122 displaying video or an image stream of a learning guide, and a lower video region for displaying a video or image stream of the student involved in a learning session at that time with the specific learning guide. A plurality of video control buttons 126 may also be included, for controlling the video feed of the learning session.

It would be appreciated that an image stream of both the instructor and the guide could be depicted on the respective computer devices, with the image stream of the guide being captured by an image acquisition device (such as a camera) on the guide operable computing device, and displaying this feed adjacent the image feed captured by a corresponding image acquisition device on the student operable computing device.

Optionally, it would be appreciated that one learning guide may have multiple concurrent video feed regions for sessions with multiple students in a group simultaneously across the network in a one-to-many type arrangement, or alternatively it may be configured so that one learning guide has a learning session with only one student at one time.

Accordingly, the above interface provides a means by which a learning guide and a student are able to interact including via the language toolbox 130, a chat 140, a text entry box 160 and an online video region 120 during a learning session when both are interconnected across the network. This interaction is in relation to the learning materials (e.g. images, text, documents etc) presented in the learning region 110, and facilitates the ability of communication between the learning guide and the student during the learning session. It would be appreciated that all aspects of the interaction which is made possible by the respective interfaces of the student and learning guide across the network could be captured for later retrieval on the database as discussed with reference to FIG. 1A.

It would be appreciated that in the depiction of the interface 100 shown, various input has been included, and such input is merely exemplary. For example the text displayed is exemplary and should not be construed as limiting to specific questions, subject matter or types of lessons designated. Furthermore the spatial arrangement and visibility of the various regions during a learning session are not limiting and exemplary only.

It would be appreciated that the regions available on the learning guide interface of the general interface 100, and the student guide interface of the interface 100 depicted could be configured to display slightly different information, with the learning guide having more detailed access to information not visible to the student. However, it would also be appreciated that some regions—e.g. the writing pad region 160 and the chat region 140 could be configured so that identical information is displayed in both regions on both the student and learning guide interface. It would also be appreciated that the writing pad region may be editable by both parties during the session, whereas the chat region 140 may be only editable by one party.

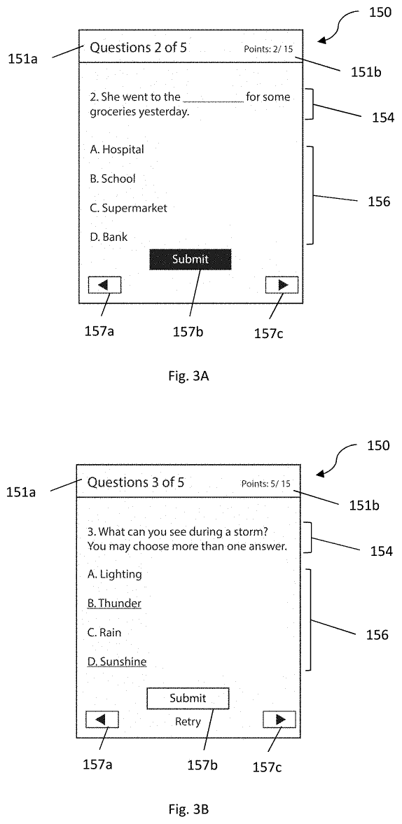

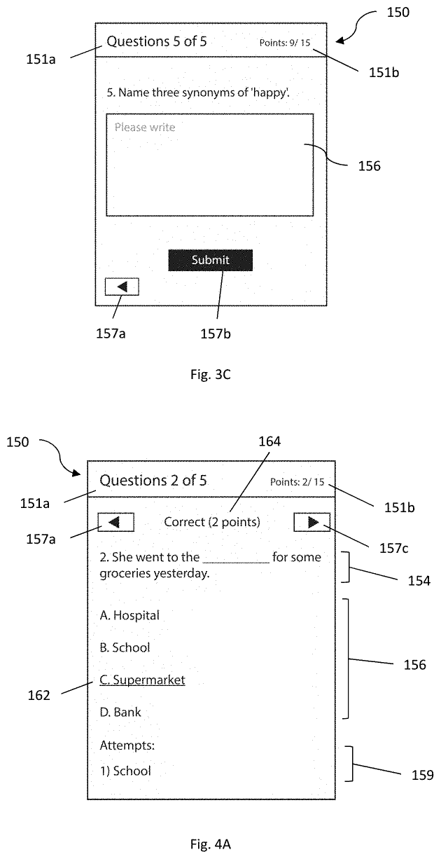

Referring now to FIG. 3A, there is depicted an exemplary question region 150 for one specific type of question, in this case, a multiple choice question element which has a single answer.

As depicted, the question region 150 includes a progression indication 151a (question 2 of 5) and a points award region 151b (in this case points 2 out of 15 possible points). The question depicted is a single answer multiple choice question, in which a single answer must be selected from the plurality of answers displayed.

As depicted, the question text is 154, and the selection of possible correct answers which the student can choose from is 156. User actuation controls 157a allows the user to change to the previous question, 157b allows the user to submit the selected answer and user control 157c allows the student to progress to the next question without answering the current question. It would be appreciated that answers could be selected by choosing an active region of the screen of the question region in a manner known to a person skilled in the art.

In this way, the student selection of an answer from the plurality of correct answers may be captured and stored for the learning session, together with such other information as time taken for the student to answer the question, the history of selections from the possible answers, and the number of times forward or backward user controls 157a, 157c have been selected.

Referring now to FIG. 3B, there is depicted a similar question region 150, in this case the question region is for a multiple choice question, in which a plurality of correct answers may be selected. Similarly, as with FIG. 3B, the question region 150 includes a progression indication 151a, the accumulated points awarded to date 151b as well as question text 154 and possible answers 156. In this case, it can be seen that two possible answers have been selected by the student in this case item B and item D, which is represented by highlighting of these answers. It would be appreciated that other ways of highlighting the selected answers could also be employed without departing from the scope of the present disclosure.

Similarly, user controls 157a and 157c allow the student to progress forward and backward to the questions, with user control 157b also allowing the user to submit the answer.

Referring now to FIG. 3C, there is depicted a further example of an exemplary question region 150, in this case for a short answer question.

Similarly, as with the question regions depicted in FIG. 3A and FIG. 3B, there is a progression indication 151a, and a number of accumulated points awarded 151b included at the top of the question. The question text 154 is displayed, together with a text input region 156 for capturing user input of possible answers. In this case, a user control back button 157a and a submission button 157b are also visible.

Accordingly, the various question regions displayed in FIGS. 3A to 3C, provide means for capturing the student selection of possible answers. It would also be appreciated that once selected, such question regions could also be configured to display each correct answer(s).

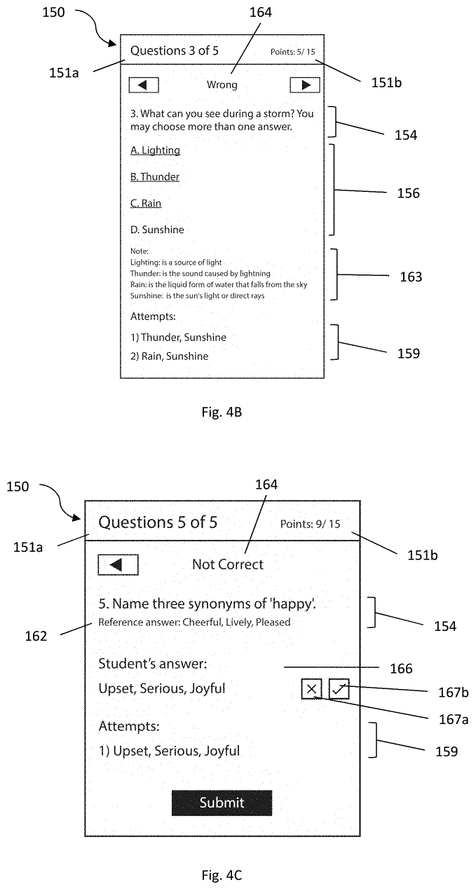

Referring now to FIG. 4A, there is depicted corresponding question regions, which are displayed on the learning guide operable computing devices as an exemplary interface.

In this case, as depicted in FIG. 4A, similar progression indication 151a, and accumulated points awarded 151b are also displayed. User controls 157a and 157c again allow the learning guide to progress through the questions.

Question text 154 is displayed for context for the learning guide, as are the list of possible answers and the selected answer 162.

In addition, a display of the previous history of attempts by the student at 159 is displayed. In the example depicted it can be seen that in the question region depicted 150, the question has already been marked as correct by the system in this case matching the answer stored for this question on the server. These points are displayed at 164. As depicted, the student selected answer is differentiated from the other plurality of answers displayed 156 as shown by the highlighting of the answer 162.

Referring to FIG. 4B, there is depicted a further example of a question region 150, from the perspective of a learning guide during the session. In the interface depicted, the progression indication 151a and accumulated points 151b are displayed. In this case, the question text is displayed at 154, in addition to the list of possible answers 156. As depicted, the student selected items have been differentiated from the non-selected items, by underlining, however other means of differentiating the text could also be used.

In this case, the student has failed to select the correct answer “C”—rain from the list of possible multiple choice answers available. Accordingly, at item 164, the question has been marked as wrong by the system. The notes on the question are provided at item 163 to the instructor to assist them in understanding the answers to the question, and the history of the student answers to the specific questions is also displayed for further reference.

It would be appreciated that having this information may enable to the learning guide to provide comments to the student, referring to the attempts, the number of selections made and other parameters as will be discussed in more detail. In this way, if chosen, the learning guide may provide direct feedback in addition to the feedback provided by the system on the answer of the student.

Such feedback could be provided orally in discussion through the exemplary video interface of the interface 100, as well as a chat in the chat region 140.

Referring now to FIG. 4C, there is provided an exemplary interface displayed on a learning guide operable computing device, in this case for a short answer type question where input is provided into a text region or similar by a student. Similarly, in this instance, the progression information of the question is depicted at 151a, and the accumulated points awarded at 151b. The overall status of the question—as to whether it is correct or incorrect may be displayed at the top of the screen 164.

In this case, the question text may be included at 154, together with a reference answer 162 for the instructor or learning guide. The student's answer entered during the session may be displayed at 166, together with buttons 167 by which the learning guide may be able to provide feedback or mark the provided answer as correct or incorrect respectively. A history of student's attempts is also displayed at item 159 which may further assist the instructor in providing input to the student.

Referring now to FIG. 5, there is depicted an exemplary learning guide operable question editor interface 180. It would be appreciated that the text of the question may be inputted as region 182, and a selection made as to the type of question at 184 between short answer and multiple choice as provided, and additional region for adding text for the exemplary correct answer may be included at 188 with a control. It may be necessary to include a pin at 186, to prevent, for example, students adding inappropriate questions. Any unauthorised users may be provided with the PIN, and upon verification may be able to include the questions in the library of questions stored on the server.

It would also be appreciated (although not shown) that a number of other attributes of the question could be specified through this interface, including the difficulty level, topic, type, link, grading criteria, and relationships with other questions, as may be known in the art by the learning guide or instructor entering the questions.

In this way, a learning guide during a session may choose to add an additional question to the bank of questions existing for the session, based upon the student's progression or lack of progression through the previous answer questions, and the particular learning resources.

The question may be then specifically categorised or re-categorised according to the student's performance, collectively or individually.

It would be appreciated that although the questions and answers are depicted in English, either or both of the question and answer text may be provided in the same language, or a different language for example, Chinese or Spanish in any combination of language pairs desired.

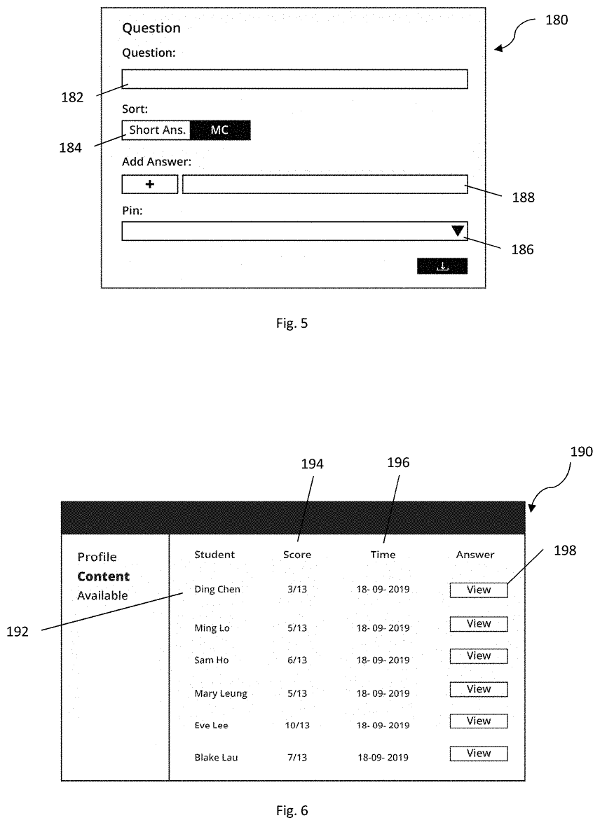

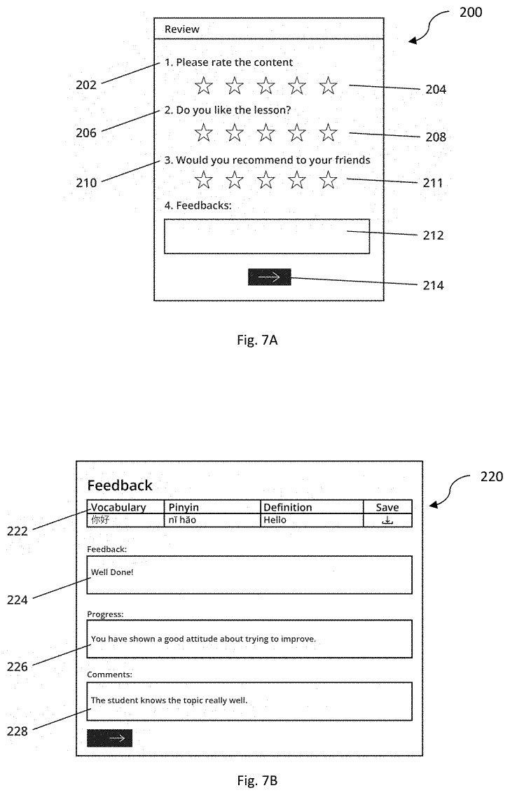

Referring now to FIG. 6, there is depicted an exemplary progression interface, in which the progression of a plurality of students through a particular learning session is depicted, with the student's name 192 (in this case Ding Chen), score 194, date of lesson 196, being shown for ease of reference. There may also be included the ability to access the questions and answers provided by the student upon actuation of the view button 198; which could trigger generation of an exemplary interface such as that depicted in FIG. 7D discussed below.

Referring now to FIG. 7A, there is depicted an exemplary post learning session feedback interface 200 in which the student is asked to provide input on the concluded learning session.

For example, the student may provide in response to the text “please rate” 202 their “starred” rating 204 for the individual session. Similarly, for whether the student liked the session 206, the student could provide their rating at 208. Similarly, for whether the student would recommend to their friends 210, their rating at 211 ends in the free text information at 211, a comment could also be provided. The submission button 214 may commit the information to a database.

Similarly, a corresponding interface 220 may be provided by which feedback from an individual learning guide on a particular session with a particular student may be captured. This interface is depicted as 220 and in the specific instance of a Chinese language learning session depicted, may include vocabulary, including characters, pinyin pronunciation and definitions at 222. Feedback may also be provided in the free form text region 224, progression information at 226 and exemplary comments at 228. In this way, feedback from both student and learning guide on a specific learning session shortly after completion may be captured, and committed to the database for future retrieval if required.

This may be reviewed by accessing a record of previous sessions which are stored on the server; as depicted for example by actuation of the review button 232, the exemplary interface 230 shown in FIG. 7C may be generated.

The question(s) addressed by a student 252, the student's answers to questions 254 and the relevant correct answer 256 may also be able to be separately retrieved from the server as depicted in the exemplary interface 250 generated in FIG. 7D.

Accordingly, with the feedback on specific sessions, as well as the presentation of the overall progression of the students through the assigned material as depicted in FIG. 6, such input provides a way in which the overall instructor, or classroom teacher, may understand the progress of the sessions, both on an individual student and/or a collective basis.

For example, an instructor may mention that a particular student had problems with a particular style of questions, in which case further remedial learning resources could be provided to that specific student. If all other students in the class had similar problems, then the leader of the group or main instructor may choose to provide further lessons and/or materials on that particular concept.

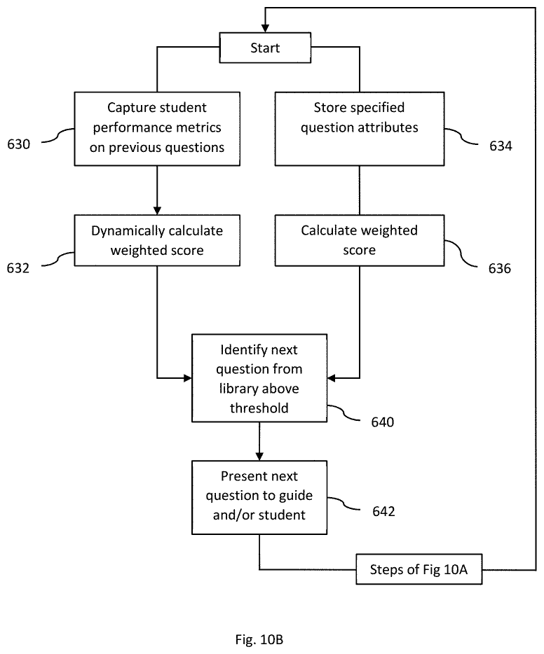

Advantageously, in the present disclosure, there is provided a way in which the next questions in a learning session may be selected according to performance of a student in that session to date, or attributes of the question itself, or a combination of both as is discussed below in reference to FIGS. 10A and 10B.

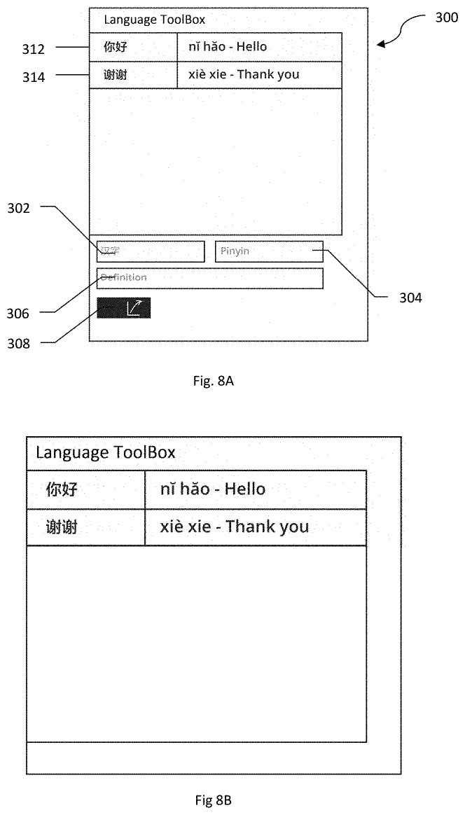

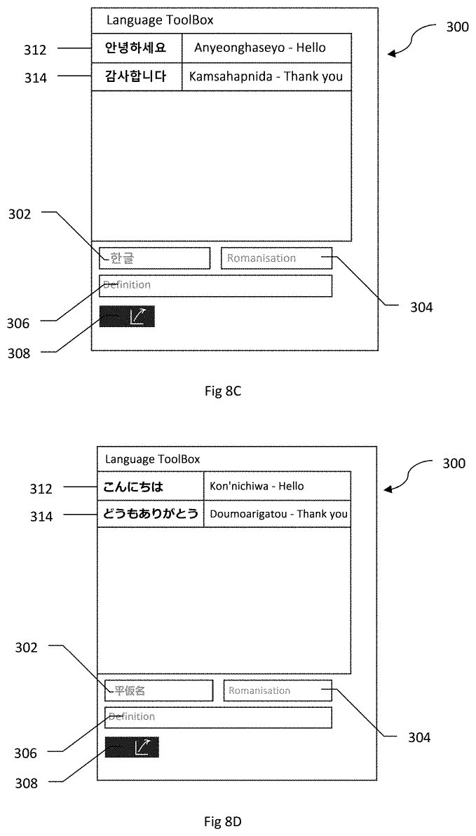

Referring now in more detail to the language resource region 130 (now represented as region 300) depicted in FIGS. 8A, 8C, 8D there is depicted exemplary representations of the language resource region from the guide or instructor perspective, whereby they are able to dynamically populate and enter elements into the lexicon displayed.

As is known in the art, a lexicon is a vocabulary list, in this case for a learning session.

As depicted in FIG. 8A, the toolbox is configured for receiving input of a Chinese character logogram or hanzi in 302, or alternatively a Romanized version of the phonetic pronunciation thereof, entered in English characters in the text entry field 304. Other morphemes, or meaningful morphological unit of a language that cannot be further divided may also be entered depending on the language pair. Where the language has logograms or symbols which represent a word or part of the word, such logograms may be the morpheme entered.

For example, Chinese has logograms whereby hanzi or characters are used; similarly Japanese has Kanji (as depicted in FIG. 8C) and Korean has hanja logograms (as depicted in FIG. 8D).

Optionally, upon entry of either the one or more logograms or the phonetic pronunciation thereof the other field may be automatically completed, based upon a match to a pre-populated database matching the two data entries. Alternatively, the instructor or guide may be able to enter the text in the field themselves.

Actuation of the user operable button 308 can result in the storage of the logogram, phonetic pronunciation and the definition into the database for the specific learning session; for display on both the student and guide operable computing device during a learning session.

As depicted, the logogram for hello in Chinese (“ [symbol] ”), phonetic representation (“n\check{i} h\check{a}o”) (in Pinyin) and the definition in English “hello” is displayed in element 312. Similarly, the logogram for thank you in Chinese (“ [symbol] ”), phonetic representation (“xièxie”) (in Pinyin) and the definition in English “thank you” is displayed in element 314 during the session. Advantageously, the elements added during a session for a specific student may be stored on a database for later retrieval and revision. Additionally, certain of the elements may be prepopulated, based upon the objective of the learning session; and able to be deleted, modified or otherwise added to by guides for a particular student during a learning session.

The student interface of the language region 300 shown in FIG. 8B has similar elements visible as in the corresponding instructor interface, however, without the ability to edit fields to specify logograms, phonetic representations or definitions.

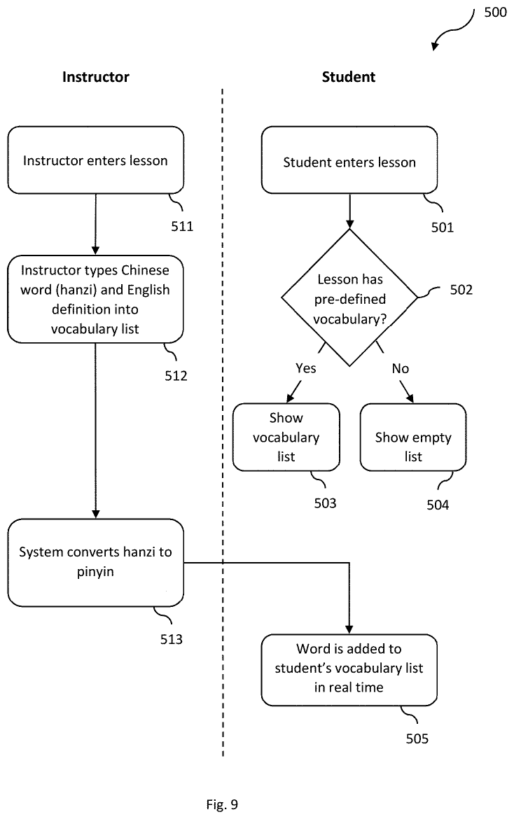

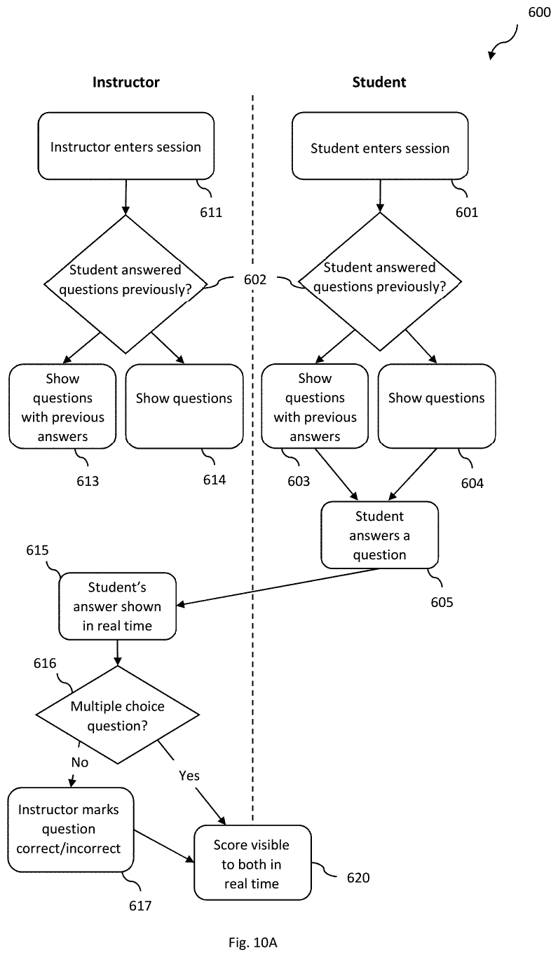

FIG. 9 is a flowchart 500 depicting the method of operation of the language resource region of FIGS. 8A-8D in an embodiment of the present disclosure. Referring to the flowchart 500, when a student enters a lesson via the student operable computing device(s) in step 501, the student operable computing device is configured to access the API server to check if there is a pre-defined vocabulary for the student in step 502.

If there is a pre-defined vocabulary for the student, the system may retrieve the pre-defined vocabulary and display it on the student operable computing device in step 503.

If there is not a pre-defined vocabulary for the student, the system will display an empty list on the guide operable computing device in step 504.

After the guide enters a lesson via the student operable computing device in step 511, the guide may add a vocabulary into a vocabulary list by inputting a Chinese word or its English definition via the guide operable computing device in step 512.

The system may automatically be configured to convert the Chinese word to Chinese Pinyin based upon previously stored records and associations for display of the converted Chinese Pinyin on the student operable computing device in step 513. Then the guide may choose to send the Chinese word input, Pinyin and definition to the student's vocabulary list across the communication network during the session, for display in step 505. Optionally, the vocabulary list may be stored for each student for each session for inclusion in subsequent session(s) and for revision thereafter. Advantageously, the process is configured to work similarly for other language pairs and based upon other input information.

In accordance with various embodiments, the system for interactive learning is configured for facilitating an instructor to conduct real-time or during learning session assessment on the learning progress of a student as depicted in FIG. 10A.

Referring to the flowchart 600, after both the instructor and the student enter a lesson via the student operable computing device and instructor operable computing device respectively in steps 601 and 611, the system is configured to check if the student has answered previously assigned questions in step 602.

If the student has answered previously assigned questions, the system may retrieve the previously assigned questions and their associated answers and display them on the student operable computing device and instructor operable computing device simultaneously.

If the student has not answered previously assigned questions, the system may retrieve the previously assigned questions only and display them on the student operable computing device and instructor operable computing device simultaneously in steps 613 and 603.

If the student submits an answer to a question via the student operable computing device in step 605, the submitted answer will be shown on the instructor computing device in real-time in step 615.

The system can be configured to check whether the submitted answer is an answer in response to a multiple-choice question in step 616.

If the submitted answer is an answer in response to a multiple-choice question, the correctness of the selected answer may be automatically determined by the system and displayed on the student operable computing device and instructor operable computing device in real-time in step 620.

If the submitted selected answer is an answer in response to a short answer question, the submitted answer will be assessed and marked with a score by the instructor in step 617. Then the score will be displayed on the student operable computing device and instructor operable computing device in step 620.

Once the question has been answered by a student, it may then be time for the next question to be selected for the student to answer, before the process steps of FIG. 10A are repeated.

As discussed, it is possible that the system may be configured to select the next question from a library of stored questions on a particular topic automatically or from a selection made prior to the lesson by an instructor, or during a lesson by a guide based upon a number of parameters.

It would be appreciated that the questions could be dynamically and automatically selected during a learning session by the system based upon multiple parameters according to pre-determined (and potentially adjustable) weightings including but not limited to: students performance data, previously specified attributes of the question and/or a combination of the above factors.

It would be appreciated that the student performance data captured at step 630 during the current and/or previous sessions in relation to preceding questions comprising one or more of the following correctness of the student's answer to one or more preceding questions. In addition the student's average response time in answering one or more preceding questions(as measured from the time the question is first displayed on the student's computing device to the time that the answer is submitted across the network, with longer answer times indicating a greater degree of difficulty or uncertainty in answering the question), and a count of the instances of switching between answer options in the one or more preceding questions with a greater number of switches between multiple choice answer options indicating a greater degree of difficulty or uncertainty in answering the question) all captured by the system.

The correctness of the student's answer to one or more of the preceding questions may have a greater weight assigned to more recently answered questions. ‘Correctness’ could be considered to be the correct selection from multiple predefined answer options, a written answer containing required key words or grammatical structures, or a spoken answer that is parsed by a speech-to-text engine and analysed for the presence of key words, grammatical structures, and accurate vocabulary usage.

These performance metrics could be used to derive an ongoing dynamically adjusted performance score for the student in the specific question, and may be further adjusted based upon their performance in other sessions at step 632.

At step 634, the system may also store in asset server or similar data structure attributes of the question including a difficulty level, topic, type, length, grading criteria, and relationships with other questions. Such question attributes may have been previously specified or may be dynamically updated during a lesson. Questions in the library may also be tagged prior to or during the session with one or more labels indicating question attributes. A weighted score for the questions could then be determined reflecting a predetermined weighting of various attributes of the questions at step 636, with such predetermined weighting potentially being able to be adjusted as required by an authorised user for specific types of students, age of students etc.

Advantageously the next question may be probabilistically selected in step 640 such that: the student's incidence of incorrect answers is shifted toward a pre-defined ratio to assist in maintaining motivation and progression. This means that weaker students may receive easier questions and stronger students receive more difficult questions; question topics may be selected to match the student's indicated areas of interest; question with attributes similar to those that the student previously answered incorrectly (or indicated uncertainty when answering) are more likely to be selected, meaning that students are to receive questions that are similar to those that they have historically performed more poorly on.

The next question may then be presented to both the learning guide and student simultaneously, or to the learning guide for preliminary review prior to display to the student.

When the selection is facilitated by the learning guide, the learning guide may search for and select questions from within the entire library of questions, or from within a smaller subset of questions that is populated algorithmically or manually using the strategies discussed above.

Alternatively, the next question may be manually selected by a guide from the plurality of questions in the library of questions.

Advantageously, the system and method the present disclosure is configured to display and receive input from both the student and the learning guide during a session, which enables any problems to be rapidly addressed and rectified without waiting until the end or conclusion of the session or some later date. The system may also provide the ability as discussed for instructors or learning guide to specify particular attributes of a question, and derive their own questions either during the learning session or at some later stage.

The present system provides an interactive learning system framework, which enable individual students and their learning guides during a session to collectively determine the progression of that session and the questions raised and addressed during a learning session. In this way, performance issues may be readily detected, and the learning session dynamically adjusted, without waiting until the conclusion of the session. Personalisation of the learning experience (potentially within constraints of specified learning objectives) is therefore possible, with the distributed learning facilitated by learning guides across a network supporting in person classroom based learning.

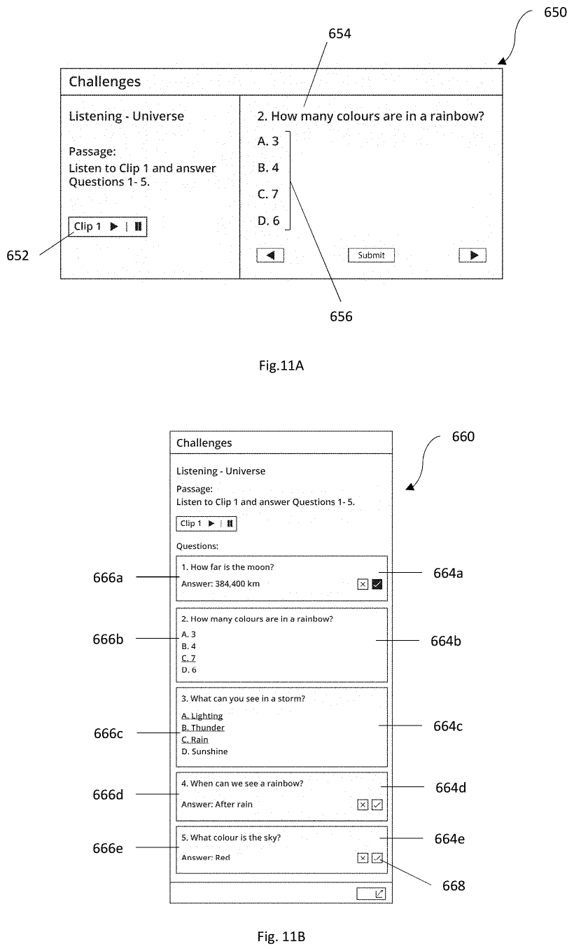

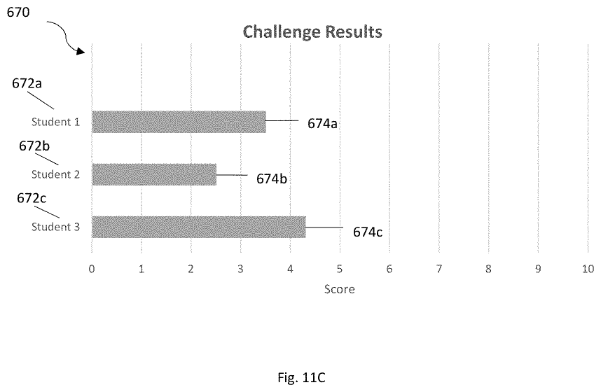

Referring to FIG. 11A there is depicted an exemplary interface 650 of a “challenge” embodiment from a student perspective. In this embodiment there is no guide operable computing device, with only multiple choice questions included in this challenge embodiment.

As depicted the students can listen to a sound clip 652 (which may be specified for inclusion from the library or recorded by an instructor) and then answer a series of questions 654, by selecting from the multiple choice answer options 656 displayed. It would be appreciated that the topic and language of the questions is exemplary only.

Referring to FIG. 11B, there is depicted an exemplary interface 660, by which the instructor is able to configure the challenge and preview the questions for the students that will be answered and comprise the challenge. The instructor may select a sound or video clip 662 from the library (or record their own) and then select from a series of questions 664a-e and associated answers 666a-e to be included in the challenge by actuation of an appropriate button 668. As depicted the correct answer may be highlighted or underlined or otherwise differentiated from the other incorrect answers, as shown. Optionally, as previously described the instructor may include their own questions and associated answers in the bank of questions, and may specify the questions and answers to be included in the challenge.

Once the challenge has been configured as depicted in FIG. 11B, and completed by the student as depicted in FIG. 11A, the results may be presented to the instructor in an exemplary interface as depicted in FIG. 11C.

The relative success of each individual student 672a-672c in answering questions which comprise a predetermined challenge may be graphically displayed as shown in the exemplary interface 670 on the instructors computing device. Based upon this information the instructor is able to determine if further or remedial learning sessions are required for particular topics, thereby providing immediate feedback to the students undertaking the challenge. It would be appreciated that the subject matter of the challenge could also include language, science, mathematics etc, and provide additional learning feedback in addition to the guide supported learning sessions between individual students and allocated guides described earlier. Other aspects of the network and configuration are essentially the same as in the assisted learning environment described above.

The above embodiments are described by way of example only. Many variations are possible without departing from the scope of the invention as defined in the appended claims.

For clarity of explanation, in some instances the present technology may be presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. An interactive learning system comprising:
at least one server communicatively coupled to a database having a plurality of student profiles and a plurality of computing devices interconnected across a network,
said plurality of computing devices comprising at least one guide operable computing device in communication with a plurality of student operable computing devices; and said at least one server being coupled to a database of learning resources including a library of questions at least some of said questions being associated with possible answers and notes;
wherein during a learning session between at least one guide operable computing device and at least one student operable computing device accessed by a student with a profile on said at least one server via the network,
the processor of the at least one student operable computing device configured for generating a student interface displaying a question from the library and capturing an answer input thereto during a learning session; and
the processor of said guide operable computing device configured for generating a guide interface displaying one or more questions; any associated possible answers and notes thereon and for displaying the answer input from the student operable computing device,
wherein said processor of the at least one guide operable computing device is further configured to capture input on said student answer input via the guide interface for transmission across the network to the at least one student operable computing device for display on the student interface during the session.

2. The interactive learning system according to claim 1 wherein the next question is automatically selected from the library according to a student's performance data comprising one or more of the following correctness of the student's answer to one or more preceding questions, the student's average response time in answering one or more preceding questions, and a count of the instances of switching between answer options in the one or more preceding questions.

3. The interactive learning system according to claim 1 wherein the next question is automatically selected from a stored library of questions according to attributes of the question including a difficulty level, topic, type, length, grading criteria, and relationships with other questions.

4. The interactive learning system according to claim 1 wherein the next question is automatically selected from the library according to a combination of the student's performance data comprising one or more of the following correctness of the student's answer to one or more preceding questions, the student's average response time in answering one or more preceding questions, and a count of the instances of switching between answer options in the one or more preceding questions; and the attributes of the question including a difficulty level, topic, type, length, grading criteria, and relationships with other questions.

5. The interactive learning system according to claim 1 wherein the next question is manually selected by a guide from the plurality of questions in the library of questions.

6. The interactive learning system according to claim 1 wherein the questions are in a format selected from the group of formats comprising multiple choice questions having one correct answer selectable from a plurality of options, multiple choice questions having at least two or more correct answers selectable from a plurality of options and a short answer question.

7. The interactive learning system according to claim 1 wherein where the question is in a short answer question format, the processor of the student operable computing device is configured for generating an interface having a region for capturing answer input from the student and a region proximal thereto for displaying during the session input received from the guide on said student answer input.

8. The interactive learning system according to claim 1 wherein where the question is in a short answer question format, the processor of the guide operable computing device is configured for generating an interface for displaying during the answer input from the student and for capturing input on the student's answer input during the learning session.

9. The interactive learning system according to claim 7 wherein the input is a performance score.

10. The interactive learning system according to claim 1 wherein the answers provided from a student operable computing device to the plurality of questions in a session together with any input received from the guide is stored against the corresponding student profile.

11. The interactive learning system according to claim 1 wherein the system is configured for providing automatically generated evaluation of a student answer input during a session for at least one or more questions for display on the interface of the student operable device, wherein the evaluation is made by comparison of the answer input to at least one or more questions and the associated answer for the at least one or more questions stored in the library of questions.

12. The interactive learning system according to claim 11 wherein the student answer input is multiple choice answer input and the correctness thereof is automatically detected and displayed on the interface generated by the guide operable computing device during the learning session by comparing the answer input against the correct answer stored for that questions in the library of questions.

13. The interactive learning system according to claim 1 wherein attributes of at least one question in the plurality of questions in the library of questions including a difficulty level, topic, type, length, grading criteria, and relationships with other questions are specified prior to or during a session.

14. The interactive learning system according to claim 1 further including an interface configured to receive from one or more authorized users additional questions for inclusion in a stored library of questions wherein at least one or more attributes of the question including difficulty level, topic, type, length, grading criteria, and relationships with other questions are also captured.

15. The interactive learning system according to claim 1 wherein the or each of the guide or student operable devices are configured to generate an interface displaying at the conclusion of the session the questions issued during the session, the answers input in response, correct answers and any comments provided thereto.

16. The interactive learning system according to claim 1 wherein a region of the interface generated on the guide operable computing device is configured for displaying a first image stream captured by an image acquisition means of the student operable computing device proximal to a second image stream captured by the guide operable computing device during the learning session; and
wherein a region of the interface generated on the student operable computing device is configured for displaying the second image stream captured by an image acquisition means of the guide operable computing device during the learning session proximal to the first image stream captured by the student operable computing device during the learning session.

17. The interactive learning system according to claim 1 wherein the questions are in a first language and the answers are in a language different from the first language.

18. The interactive learning system according to claim 1 wherein the processor of the guide operable computing device is configured for generating an interface during a learning session including a lexicon region having at least one or more editable elements, each element associating input of a morpheme in a first language or a corresponding phonetic representation thereof with a definition in a second language; wherein said lexicon and any modifications thereof are transmitted via the server to the or each student operable computing device during a learning session.

19. The interactive learning system according to claim 18 wherein an element is included in the lexicon region by receiving input comprising a morpheme or phonetic representation and displaying the corresponding morpheme or phonetic representation retrieved from a plurality of stored associations between morphemes and phonetic representations; and for receiving a specified definition thereof for transmission of that element and any modifications thereto via the server to the or each student operable computing device in the learning session.

20. The interactive learning system according to claim 19 wherein the morpheme comprises at least one or more logograms.

21. The interactive learning system according to claim 20 wherein the at least one or more logograms is a Chinese hanzi, Korean hanya or Japanese kanji character and the corresponding phonetic representation is an English language Romanisation thereof.

22. The interactive learning system according to claim 21 wherein the lexicon region of the interface is dynamically updated by the guide during the learning session to display elements thereof on the interface generated by the student operable computing devices.

23. The interactive learning system according to claim 21, wherein the lexicon region of the interface includes a plurality of elements specified by an instructor prior to commencement of the learning session; said elements being able to be added to, deleted or modified by the guide during the learning session.

24. The interactive learning system according to claim 18 wherein the elements in the lexicon region of each learning session for each student are stored on the server.

25. An interactive learning system comprising:
at least one server communicatively coupled to a database having a plurality of student profiles and a plurality of computing devices interconnected across a network,
said plurality of computing devices comprising at least one instructor operable computing device having a processor configured for communication with a plurality of student operable computing devices; and said server being coupled to a database of learning resources including a library of questions and associated correct answers;
wherein the processor of said instructor operable computing device is also configured for generating an interface for specifying one or more questions to be assigned to a learning session for answering by at least one or more students; and
wherein during a learning session established between the server and at least one student operable computing device accessed by a student with a profile on said server via the network, the processor of the at least one student operable computing device is configured for
generating a student interface displaying an assigned question from the library;
capturing an answer input thereto during a learning session; and
displaying a determination of the correctness thereof based upon a comparison with the associated correct answer on the server for the assigned question.

26. A non-transitory computer readable storage medium storing one or more programs, the one or more programs comprising instructions, which when executed by an electronic device with a display, cause the device to perform operations including:
establishing a learning session with at least one student operable computing device across a network via at least one server; said at least one student operable computing device being authenticated by locating a corresponding student profile in a database coupled to the at least one server;
generating a guide interface displaying one or more questions; any associated possible answers and notes thereon in a database of learning resources including a library of questions at least some of said questions being associated with possible answers and notes;
displaying the answer input from the student operable computing device on said guide interface;
capturing input on said student answer input via the guide interface for transmission across the network to the at least one student operable computing device for display on the student interface during the session.

27.-30. (canceled)
